(19) United States
(12) Patent Application Publication
(10) Pub. No.: US 2004/0066095 A1
(43) Pub. Date: Apr. 8, 2004

(54) Apparatus for controlling transmissions to reduce electromagnetic interference in an electronic system

(75) Inventors: Andrew Michael Cherniski, Rescue, CA (US); Ricardo Espinoza-Ibarra, Carmichael, CA (US); Andrew Havery Barr, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Company, Fort Collins, CO

(21) Appl. No.: 10/263,587

(22) Filed: Oct. 2, 2002

(51) Int. Cl. H02B 1/24

(52) U.S. Cl. 307/116

(57) ABSTRACT

An apparatus for reducing electromagnetic interference in an electronic system, comprises a switch coupled to a conductive line, and a system management device that can be coupled to the electronic system. The system management device detects whether a device is connected in a particular location in the system, and opens the switch to disable data transmission a long the conductive line to the particular location when the device is not connected. Noise signals are thus prevented from being propagated on transmission lines that are not terminated, and EMI that can be generated by signal reflections on the unterminated conductive line is substantially reduced, if not eliminated.

### BACKGROUND OF THE INVENTION

1. Field of the Invention

The invention relates generally to devices for reducing electromagnetic interference and specifically for devices for reducing electromagnetic interference in an electronic system by controlling transmissions to one or more conductive lines in electronic systems and networks.

2. Relevant Background

Whenever an electric charge is accelerated, electromagnetic waves are generated. Typical electric and magnetic fields in electronic circuits are generated by current pulses propagating along a path or a loop within the circuit. Each current pulse that propagates along the path creates a magnetic field perpendicular to the plane of the current path. The resulting voltage drop along the path creates an electric field opposite to the propagation direction and within the same current plane. Most common current paths within a personal computer consist of I/O cables, printed circuit board (PCB) signal traces, power supply cables, and power-to-ground loops. These paths can act as antennae, radiating electric and magnetic fields that cause EMI by interacting with other signals. The magnitude of EMI is a function of several characteristics of the transmitted signal, such as its frequency, duty cycle, edge rate, and voltage swing (amplitude). This EMI may result in erroneous transmission of data, lost data, or a reduction in the amount of acceptable noise for that system.

As the computer market evolves, increasingly higher-speed data processing and transmission technologies are being developed. Electronic components and circuits, such as microprocessors, operate at increasingly higher frequencies and lower voltages and are increasingly more susceptible to electromagnetic interference (EMI). Unfortunately, nearly any computer system has the potential for causing EMI during operation.

Another source of EMI, aside from I/O cables, PCB signal traces, power supply cables, and power-to-ground loops, can arise when high-speed data is transmitted to the pins of an unterminated connector. In this situation, the open pins act as small antennae that radiate the transmitted signals. These open pins have been observed to generate up to 10 decibels or more of EMI. The EMI can interfere with other components within the computer system as well as other susceptible electronic systems that may be nearby. Thus, whether the open pins reside within or outside of a computer system housing, it is desirable, and in some situations necessary, to reduce these emissions to acceptable levels.

In the prior art, various techniques are recommended to reduce EMI in data transmission lines. See “Characteristics and Measurement Techniques of the Spectral Content of Signals Generated by High-Performance ICs”, Fairchild Semiconductor Application Note, June 1992 (AN-831), revised November 1999 (AN010998). One technique known as the parallel termination scheme matches the effective impedance of the transmission line with a resistor coupled in parallel. Another technique known as the series termination scheme places a resistor in series with the output driver and the transmission line. The resistor value is selected such that when added to the integrated circuit (IC) output resistance, the total equals the effective impedance of the transmission line. This effectively forms a voltage divider with the transmission line producing a half-voltage level at the source which doubles upon reflection at the end of the line. These techniques are applicable to distributed or point-to-point data transmissions, respectively, but do not address the issue of open connector portions at the end of the transmission medium.

Similarly, other components such as ferrite cores and beads, feedthrough capacitors, connector shields, gaskets, and conductive tapes can all prevent unwanted EMI signals, as known in the art. These techniques are not suitable, however, for use on connector pins because the components would interfere with mating the pins to a corresponding female connector. It is therefore desirable to provide a device for reducing, and even eliminating, EMI propagated by signals being transmitted to unterminated connectors.

### SUMMARY

In one embodiment, an apparatus for controlling transmissions to reduce electromagnetic interference in an electronic system comprises a switch coupled to a conductive line, and a system management device that can be coupled to the electronic system. The system management device detects whether a device is connected in a particular location in the system, and opens the switch to disable data transmission along the conductive line to the particular location when the device is not connected. Noise signals are thus prevented from being propagated on transmission lines that are not terminated, and EMI that can otherwise be generated by signal reflections on the unterminated conductive line is substantially reduced, if not eliminated.

In accordance with one aspect of the apparatus, the system management device tracks inventory of a plurality of devices connected to a corresponding plurality of locations in the system.

In another aspect, the system management device detects when one of the plurality of devices is disconnected from the corresponding location in the system.

In a further aspect, the system management device and the plurality of devices can be coupled to a communication bus.

In still another aspect of the apparatus, one of the plurality of devices is a hub comprising a second plurality of switches. The system management device can communicate signals to the hub to open and close each of the second plurality of switches.

In yet another aspect of the apparatus, the hub utilizes an arbitrated loop protocol.

In another aspect of the apparatus, the hub utilizes a fiber channel arbitrated loop protocol.

In another aspect of the apparatus, an identifier module on the device can indicate to the system management device whether the device is connected to the particular location.

In another aspect of the apparatus, a terminating device can indicate to the system management device whether the device is connected to the particular location.

In another aspect of the apparatus, the terminating device can pull a designated pin on a connector portion to a designated state to indicate to the system management device whether the device is connected to the particular location.

In another embodiment, a computer system includes a connection plane with a plurality of connector portions and a communication bus. A system management device is coupled to one of the connector portions. The system management device includes a logic module to detect when other devices are connected and disconnected to the plurality of connector portions via the communication bus. The logic module can also indicate whether the other devices are part of an arbitrated loop network, and transmit a signal to disable transmission to at least one of the connector portions when the device is disconnected.

In one aspect, the computer system includes a hub with a port bypass circuit. The hub can support arbitrated loop capability, such as fiber channel arbitrated loop (FC-AL).

In an aspect of a computer system that supports FC-AL, the hub can receive data via optical fiber and transmit data via electrically conductive wire. The hub includes one or more port bypass circuits that each include a switch. The switches can be opened and closed by a system management device that communicates with the hub via a communication bus.

In another aspect, an identifier module indicates to the system management device whether one of the other devices is connected.

In another aspect of the apparatus, a terminating device indicates to the system management device whether one of the other devices is connected by setting the state of a designated pin in the connector portion, to which the terminating device is connected, to a designated value.

### BRIEF DESCRIPTION OF THE DRAWINGS

The features of the described embodiments believed to be novel are specifically set forth in the appended claims. However, embodiments of the invention relating to both structure and method of operation, may best be understood by referring to the following description and accompanying drawings.

FIG. 1A is a block diagram of an example of a server system that can utilize an apparatus for controlling transmissions to reduce electromagnetic interference in accordance with an embodiment of the present invention.

FIG. 1B is a block diagram of examples of functions performed by a system management blade that can be utilized in the server system shown in FIG. 1A.

FIG. 2A is a diagram of an example of a fiber channel arbitrated loop network in which various embodiments of the present invention can be utilized.

FIG. 2B is a diagram of an example of a dual port bypass circuit which can be utilized in the fiber channel arbitrated loop network shown in FIG. 2A.

FIG. 3A is a block diagram of an example of a system management blade that includes a function to set registers in a port bypass circuit in accordance with an embodiment of the present invention.

FIG. 3B is a flow diagram of an embodiment of a Set PBC Registers function in the system management blade shown in FIG. 3A.

FIG. 4A is a diagram of an example of an airflow guide on which a module for identifying a “null” device to the system management blade is provided in accordance with an embodiment of the present invention.

FIG. 4B is a side cross-sectional view of the airflow guide shown in FIG. 4A.

FIG. 4C is a flow diagram of an embodiment of an enable/disable transmit function in the system management blade shown in FIG. 4A.

FIG. 5A is a diagram of an example of a terminating device coupled to communicate with a system management blade in accordance with an embodiment of the present invention.

FIG. 5B is a flow diagram of an embodiment of a Set PBC Registers function in the system management blade shown in FIG. 5A.

### DETAILED DESCRIPTION

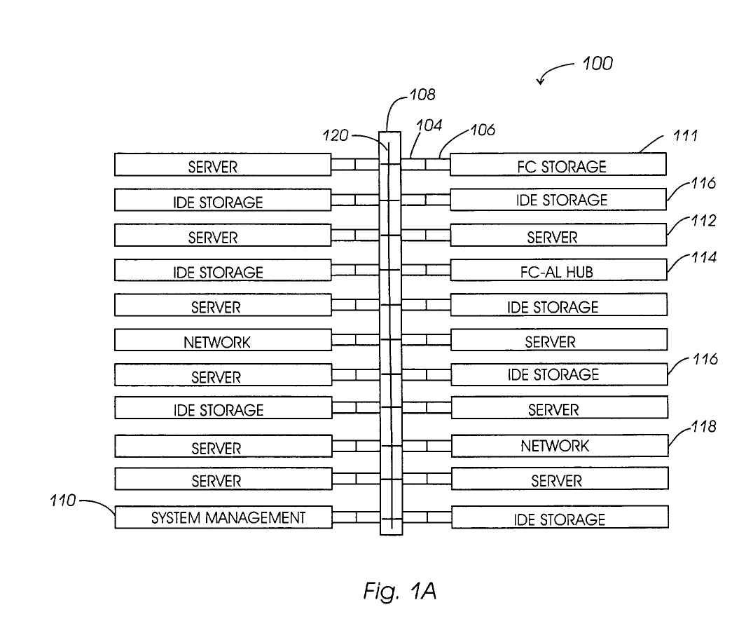

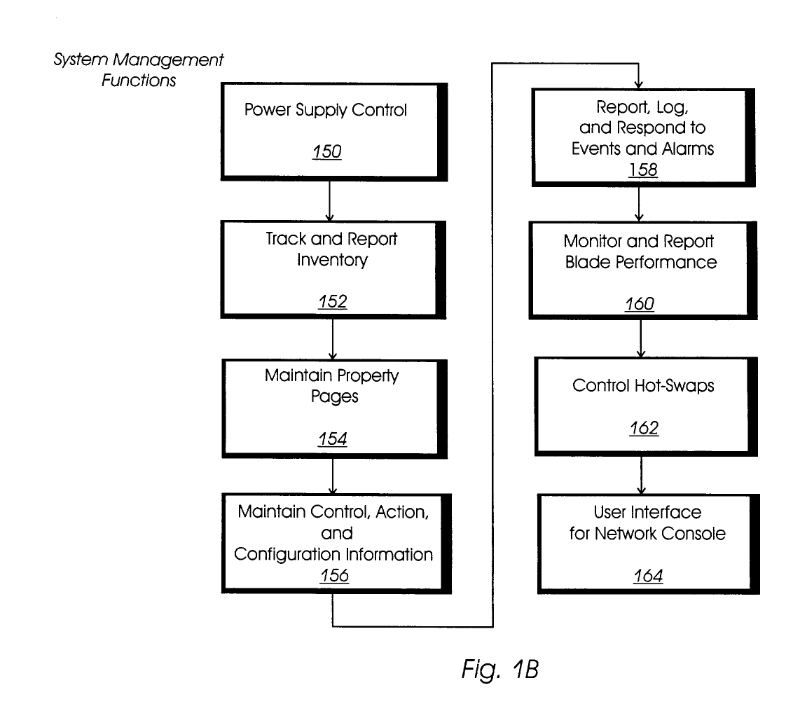

Referring now to FIG. 1A is a block diagram of an example of a server system 100 that can utilize an apparatus for controlling transmissions to reduce electromagnetic interference in accordance with an embodiment of the present invention. Server system 100 includes slots in which removable blades can be inserted. When one or more of the blades is disconnected from mid-plane 108, connector portion 104 on mid-plane 108 is left unterminated. As described hereinabove, EMI can propagate on the unterminated connector portions 104, which can cause problems such as missing or erroneous data in blades connected to mid-plane 108 or other susceptible components outside of server system 100. To help reduce this EMI, a device for controlling transmissions to unoccupied slots can be included in one or more of the blades.

An example of a blade that can include a function or device to control transmission to unoccupied slots is system management blade 110, which performs a central role including event reporting, configuration and inventory management, hot-swap control, and provides local panel and network operations center (NOC) console user interfaces.

FIG. 1B is a block diagram of examples of functions typically performed by an embodiment of system management blade 110 that can be utilized in the server system 100 shown in FIG. 1A. The functions are performed for blades connected to mid-plane 108 and can include Power Supply Control 150; Inventory Tracking And Reporting 152; Maintaining Property Pages 154; Maintaining Control, Action, And Configuration Information 156; Reporting, Logging, And Responding To Events And Alarms 158; Monitoring And Reporting Blade Performance 160; Controlling Hot-Swaps 162; and Network Console User Interface 164. The functions of system management blade 110 can be implemented in hardware, software, firmware, or a combination of hardware, software, and firmware components.

In the embodiment shown, server system 100 supports various components attached to various types of blades connected to mid-plane 108. In some embodiments, a chassis for server system 100 can support dual power grids (not shown), redundant paths to system management blade 110, FC storage blade 111, server blade 112, redundant fiber channel busses via FC-AL hub blade 114, Integrated Drive Electronics (IDE) storage blade 116, cooling fans (not shown); redundant network blades 118; and load-balanced power supplies (not shown).

Server system 100 supports a variety of configurations of different types of blades, or entirely of one type of blade. One such chassis to support server system 100 is the commercially available compact peripheral component interconnect (cPCI) Blade Server Chassis, Model Number bh7800, from Hewlett-Packard Company in Palo Alto, Calif. While server system 100 is used as an example herein, it is anticipated that various embodiments of the present invention can be utilized in various types of systems where unterminated connector portions can emit EMI.

Mid-plane 108 can support and/or include one or more communication buses 120 for the blades in server system 100 and includes one or more connector portions 104 for each slot in the chassis. For example, when server system 100 utilizes the cPCI bus standard, connector portion 104 is included in each slot of mid-plane 108 for all power, ground, 32 bit, and 64 bit PCI signals. Components on the blades are coupled to corresponding connector portions 106. These optional connectors can be used for a variety of purposes such as a bridge to other communication buses 120 in mid-plane 108. In some embodiments, one of communication buses 120 conform to the compact Peripheral Component Interconnect (cPCI) bus standard, and another of communication buses 120 conform to the Inter-IC (I²C) bus standard. Other suitable bus structures and protocols can be utilized in addition to, or instead of, the cPCI and I²C bus on communication buses 120.

In some embodiments, mid-plane 108 also includes an EEPROM that allows mid-plane 108 to identify itself to system management blade 110 for inventory and configuration tracking, and an FET (field effect transistor) for each slot that allows the blades to operate when system management blade 110 is removed. Industry-standard Ethernet, SCSI, and Fiber Channel (FC) interfaces to mid-plane 108, as well as other interfaces, can be utilized.

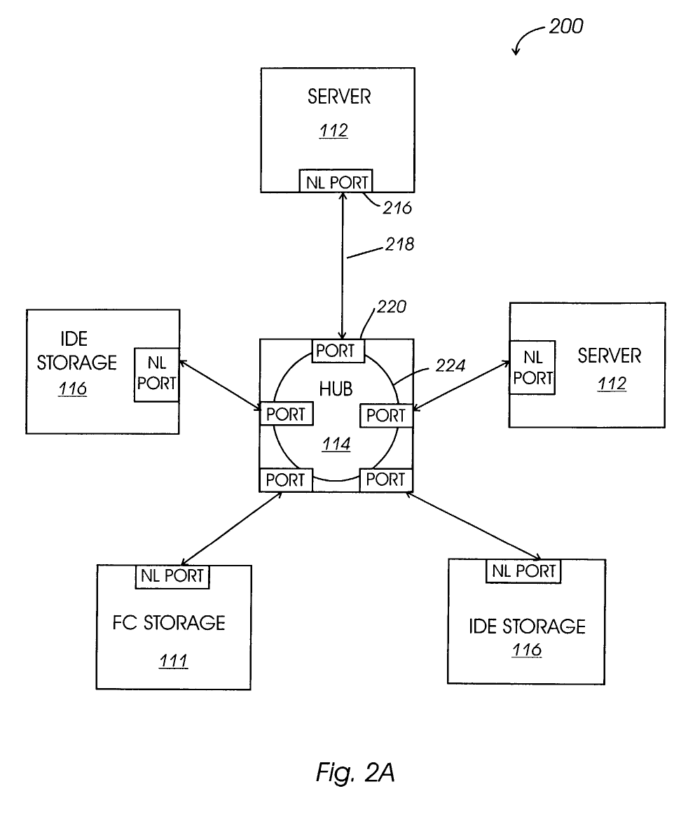

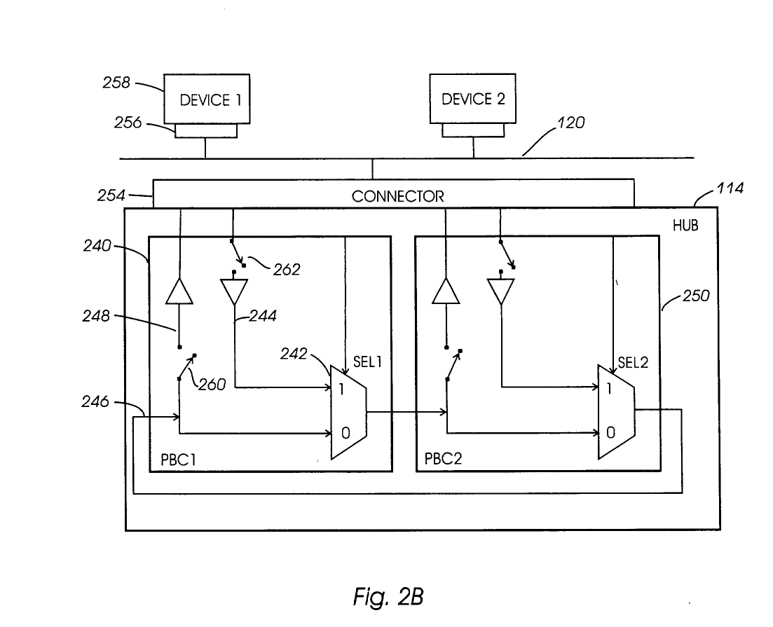

FC storage blade 111 provides storage medium that can be accessed by devices on nodes that are part of FC-AL network 200 (FIG. 2A).

Server blades 112 can include a range of components from a complete server with on-board storage memory to one or more high-performance reduced instruction set computing (RISC) processors.

Fiber Channel Arbitrated Loop (FC-AL) hub blade 114 enables the use of fiber channel buses embedded in mid-plane 108 and a FC connection to via connector portions 104. FC-AL hub blade 114 can be implemented with port bypass circuits, such as PBC 240 (FIG. 2B) as described herein to provide fiber channel arbitrated loop capability.

Integrated Drive Electronics (IDE) storage blade 116 provides redundant arrays of independent disks (RAIDs) to store the same data redundantly on multiple hard disks, thereby improving fault tolerance and reliability. IDE storage blade 116 can typically store large amounts of data and can be accessed via mid-plane 108 by server blades 112 having an appropriate interface.

Network blade 118 provides an interface between a local area network and a wide area network, typically via an Ethernet interface. Network blade 118 includes components that perform tasks such as routing, prioritization, security, bandwidth management, and network management. A console connected to network blade 118 can provide user interfaces to monitor and control hubs, switches, ports, and traffic over a network.

Referring now to FIG. 2A, a block diagram of an example of a fiber channel arbitrated loop (FC-AL) network 200 is shown with which various embodiments of the present invention can be utilized. While FC-AL network 200 is used as an example herein, it is anticipated that various embodiments of the present invention can be utilized with any type of device, server, network (including peer-to-peer and wide area networks), or other systems where unterminated connector portions can cause EMI. Various embodiments of the present invention can also be utilized in any type of system that utilizes data transfer infrastructure and protocols instead of, or in addition to, fiber channel.

FC-AL network 200 can provide high bandwidth data transfer between up to one-hundred and twenty-six devices. In some embodiments, FC-AL network 200 allows multiple devices, each called “a node,” to be connected together. A node may be any device or group of devices, such as computer workstations (not shown), FC storage 111, server 112, storage disk arrays 116, tape libraries (not shown), and/or printers (not shown), having an interface allowing it to be connected to FC-AL network 200.

Each node communicates with all other nodes on FC-AL network 200. During initialization of FC-AL network 200, each device is assigned an address. These addresses may be assigned in various ways including manually, dynamically, or by wiring the rear of the rack where the devices are installed. When a device is ready to transmit data, the device transmits its address onto FC-AL network 200. When the sending device receives its own address, the device becomes the master of the FC-AL network 200 and can communicate with the addressee. FC-AL network 200 therefore supports one active connection between two devices at a time, so control of the FC-AL network 200 must be arbitrated, usually according to priority, when more than one device requests a connection.

Each node has at least one port, referred to as node-loop (NL) port 216, to provide access to other nodes. NL ports 216 are the connections in a fiber-channel node through which data may pass over the fiber channel to NL ports 216 of other nodes. A typical fiber-channel drive has two NL ports 216 packaged within the drive's node. Each NL port 216 includes a pair of “fibers”—one to carry information into NL port 216 and one to carry information out of NL port 216. Each “fiber” is a serial data connection, and, in one embodiment, each fiber is a coaxial wire (e.g., coaxial copper conductors, used when the nodes are in close proximity to one another); in other embodiments, a fiber is implemented as an optical fiber over at least some of its path (e.g., when nodes are separated by an appreciable distance, such as nodes in different cabinets or, especially, different buildings). The pair of fibers connected to each NL port 216 is referred to as a link 218. Links 218 carry information or signals packaged in “frames” between nodes. Each link 218 can handle multiple types of frames (e.g., initialization, data, and control frames). One example of a link is bus 120 (FIG. 1A)

Each node is directly attached to one of hub ports 220 of FC-AL hub blade 114 by link 218. Arbitrated loop 224 is typically implemented inside FC-AL hub blade 114. Generally, FC-AL hub blade 114 will have between seven to ten ports 220, and a maximum number of devices, e.g., 126 devices, can be connected to arbitrated loop 224 by linking several hubs 114 together.

An advantage of FC-AL hub blade 114 is that each hub port 220 includes port bypass circuit (PBC) 240, such as shown for example in FIG. 2B. If hub port 220 detects that a device is absent or not responding, hub port 220 closes PBC 240, thereby preserving the continuity of arbitrated loop 224. PBC 240 prevents a failing device or connection from bringing down the entire arbitrated loop 224 and also allows hot-swapping, which is the ability to add and remove devices while arbitrated loop 224 is active. An example of PBC 240 suitable for use in arbitrated loop 224 is port bypass circuit model number VSC7148, which is commercially available from Vitesse Semiconductor Corporation in Camarillo, Calif.

In the example of PBC 240 shown in FIG. 2B, PBC 240 includes a multiplexer 242 that is controlled by the SEL1 line. When an operational device 258 is in communication with hub port 220 (FIG. 2A), the SEL1 line is set HIGH, and external input line 244 is selected. Otherwise, the SEL1 line is set LOW and output line 246 of previous PBC 250 is selected since there is no connected or functional device that can provide input to hub port 220.

FC-AL hub blade 114 and device 258 interface with bus 252 via connectors 254, 256, respectively. Transmit line 248 transmits data to the corresponding device 258 via bus 252. PBC 240 includes several registers that can be set via an application programmer interface (API) to PBC 240 to control operation of components in PBC 240 such as transmit enable switch 260 and receive enable switch 262. In general, FC-AL hub blade 114 toggles SEL1 to bypass device 258 when device 258 is disconnected, while transmit enable switch 260 and receive enable switch 262 remain closed.

One problem that arises when output line 246 of previous PBC 250 is selected is that the data is transmitted not only to multiplexer 242, but also along transmit line 248. Lines coupled to connector 254, such as transmit line 248, carrying data with fast edge rates or that are continuously active, such as clocks or data lines, should be terminated. Additionally, a line may pick up and transmit noise from other lines. When device 258 is not connected to bus 252, transmit line 248, as well as other lines coupled to connector 254 that are capable of conducting noise signals, should be terminated when they are “long” compared to the wavelength of the applied frequency of the signal. If transmit line 248 is not terminated in its characteristic impedance, a signal reflection will occur. The amplitude of the reflection depends on the amount of impedance mismatch between transmit line 248 and the load, which is infinite when transmit line 248 is not terminated. The amplitude of the reflection also depends on the rise time of the signal as well as the rise time of the signal compared to the length of the conductor in transmit line 248. It is also desirable to terminate other lines coupled to connector 254, such as receive line 262, that are capable of conducting noise signals.

When device 258 is disconnected from connector 256, the portion of connector 256 coupled to bus 252 is typically left open. In the presence of signals at the appropriate frequency and amplitude, conductive parts, such as pins, in the open portion of connector 256 can act as antennae, radiating EMI that can disrupt operation of other devices within susceptible range.

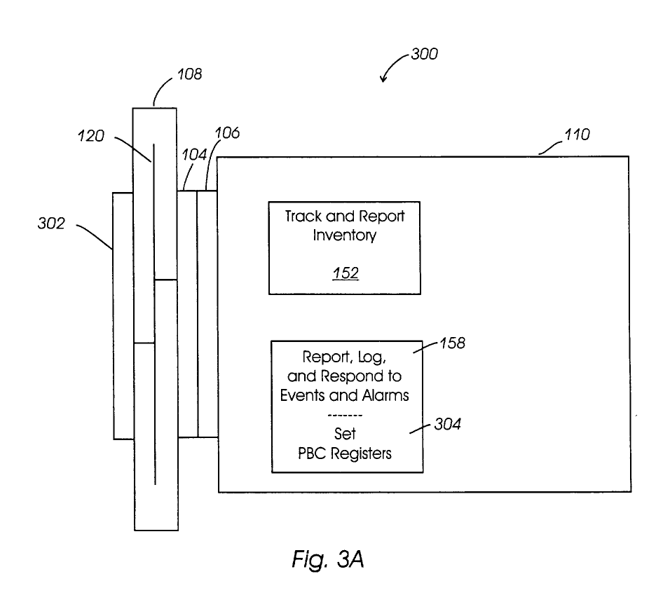

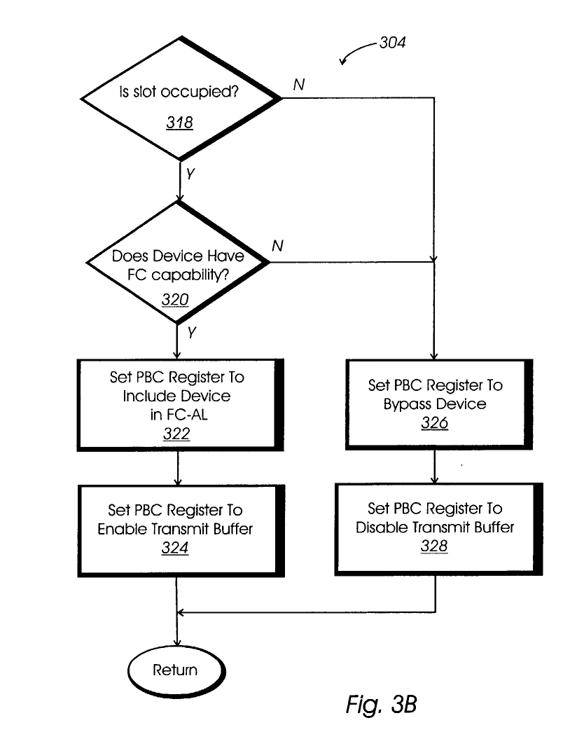

Referring now to FIGS. 3A and 3B, FIG. 3A is a block diagram of an example of system management blade 110 that performs Set Port Bypass Circuit (PBC) Registers function 304 in accordance with an embodiment of the present invention, to reduce EMI in an electronic system or network. Some devices that connect to mid-plane 108 include a Field Replaceable Unit Identifier (FRU-ID) module (not shown) that sends signals over communication bus 120 to system management blade 110 that allow Track and Report Inventory function 152 keep an accurate and timely record of devices connected to and disconnected from mid-plane 108. Connector portion 302 is coupled to mid-plane 302 to communicate with system management blade 110 via bus 120. When a slot for supporting a device is vacant, connector portion 302 is left open.

In some embodiments Track and Report Inventory function 152 can use a Serial Presence Detect (SPD) mechanism, as known in the art, to detect the presence of a blade or other device in a slot. When a device is initially connected or disconnected to mid-plane 108, Report, Log, and Respond to Events and Alarms function 158 records the event and performs any functions needed to accommodate the change to server system 100 (FIG. 1A). Track and Report Inventory function 152 can also retain information regarding slots that are capable of interfacing with FC-AL hub blade 114 (FIG. 1A) to provide fiber channel functionality.

In accordance with an embodiment of the present invention, a function such as Set PBC Registers function 304 can be performed when Track and Report Inventory function 152 detects that a blade has been connected to or disconnected from mid-plane 108. Note that Set PBC Registers function 304 can be a standalone function, or included as part of another function, such as Reporting, Logging, And Responding To Events And Alarms function 158 as shown in FIG. 1B. Additionally, Set PBC Registers function 304 can be implemented in hardware, software, firmware, or a combination of hardware, software, and firmware components.

FIG. 3B is a flow diagram of an embodiment of Set PBC Registers function 304. In the embodiment shown, function 318 determines whether the slot is occupied based on information from Track and Report Inventory function 152. Note that not all blades in a fiber channel enabled slot may be capable of interfacing with FC-AL hub blade 114 (FIG. 1A), therefore Set PBC Registers function 304 can access information maintained by Track and Report Inventory function 152 to determine whether the device has fiber channel capability in function 320. The information in Track and Report Inventory function 152 can include a pre-programmed list of device identifiers and corresponding indicators of whether the device includes fiber channel capability. In other embodiments, the device can send an indicator of whether it has fiber channel capability when it is connected.

Referring to FIGS. 2A, 2B, and 3B, if the slot is occupied and the device occupying the slot has fiber channel capability, function 322 sets one or more registers to include the device in the FC-AL network 200. Function 324 sets one or more registers and to enable (close) transmit switch 260 in PBC 240.

If the slot is not occupied, or the device occupying the slot does not have fiber channel capability, function 326 sets one or more registers to bypass the device in the FC-AL network 200. Function 328 sets one or more registers and to disable (open) transmit switch 260 in PBC 240.

As described for FIG. 2B, PBC 240 includes registers that can be set via an application programmer interface (API) to open and close transmit switch 260 and receive switch 262. When transmit switch 260 is open, signals from previous PBC 250 are not conducted past transmit switch 260. The reflections that can occur when transmit line 248 is unterminated are minimized, and as a result, there are no noise signals to be radiated by open connector portion 302 (FIG. 3A).

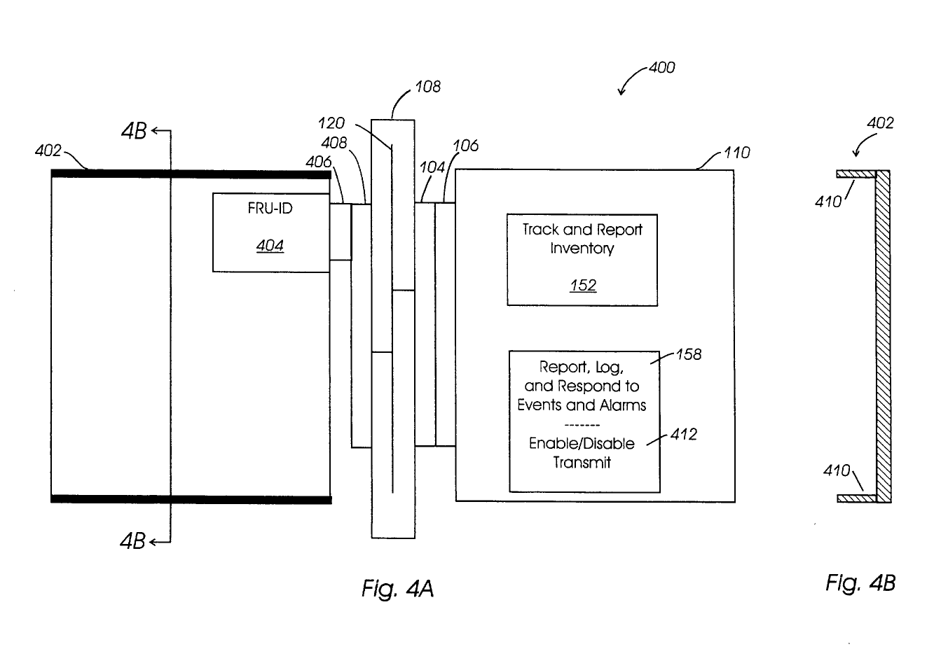

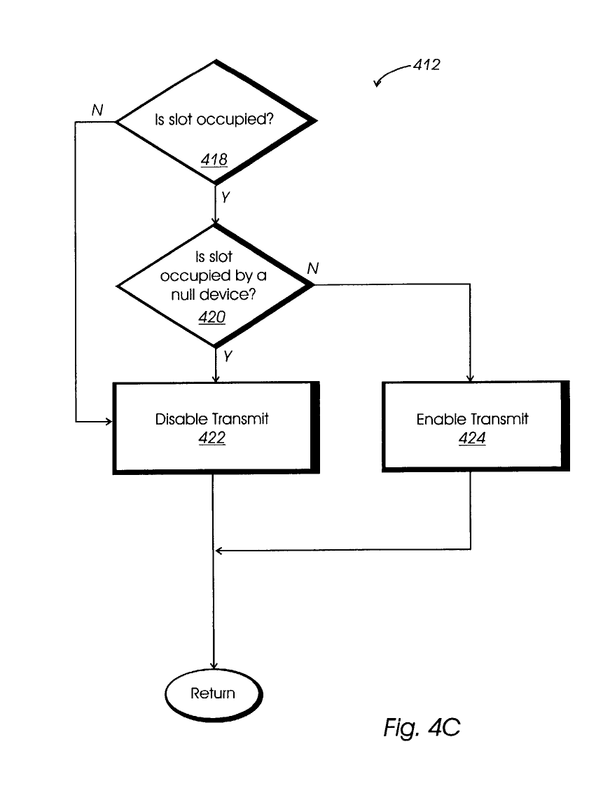

Referring to FIGS. 2B and 4A, FIG. 4A is a diagram of another embodiment of the present invention showing a null device, such as airflow guide 402, with Field Replaceable Unit Identifier (FRU-ID) module 404 for identifying the null device to system management blade 110. FIG. 4B is a side cross-sectional view of airflow guide 402 shown in FIG. 4A, that includes air blocking members 410 to prevent cooling air from flowing past airflow guide 402. The cooling air is redirected to flow past blades with active components and circuits that require cooling. Airflow guide 402 also includes connector portion 406, which mates with connector portion 408. Note that connector portion 406 may only mate with part of connector portion 408, which leaves the remaining connector portion open to radiate EMI as described hereinabove. Thus, it is desirable to open transmit switch 260 to prevent any signals on transmit line 248 from being broadcast by the open part of connector portion 408.

To determine when to open transmit switch 260, FRU-ID module 404 transmits signals to identify airflow guide 402 to system management blade 110. Thus, when airflow guide 402 is inserted in an open slot, a function such as Track and Report Inventory function 152 detects the slot as being occupied by a null device, i.e., airflow guide 402, and reports the event to Report, Log, and Respond to Events and Alarms function 158. A function such as Enable/Disable Transmit function 412 to enable or disable transmissions to the slot (and connector portion 408) can then be invoked.

In some embodiments, Enable/Disable Transmit function 412 can open or close transmit switch 260 associated with PBC 240, similar to the embodiment of Set PBC Registers function 404 shown in FIG. 4B. In other embodiments, switches associated with transmit lines can be controlled regardless of whether the lines are coupled to PBC 240 or the device has fiber channel capability.

Referring to FIGS. 2B and 4C, an embodiment of Enable/Disable Transmit function 412 is shown in FIG. 4C. Function 418 determines whether a slot is occupied by accessing information maintained by Track and Report Inventory function 152 (FIG. 4A). If the slot is not occupied, function 422 disables transmissions on transmit lines associated with the slot. Function 420 determines whether the slot is occupied by a null device, such as airflow guide 402 connected to connector portion 408 (FIG. 4A). If a null device is connected, function 422 disables transmissions on transmit lines associated with the slot. If the slot is occupied by an operational device (i.e., not a null device), function 424 enables transmissions on transmit lines associated with the slot.

Thus, a system configured in accordance with an embodiment of the present invention can provide the ability to control transmissions on a variety of transmit lines, in addition to transmit lines associated with PBC 240 (FIG. 2B). This capability can greatly reduce EMI in the system.

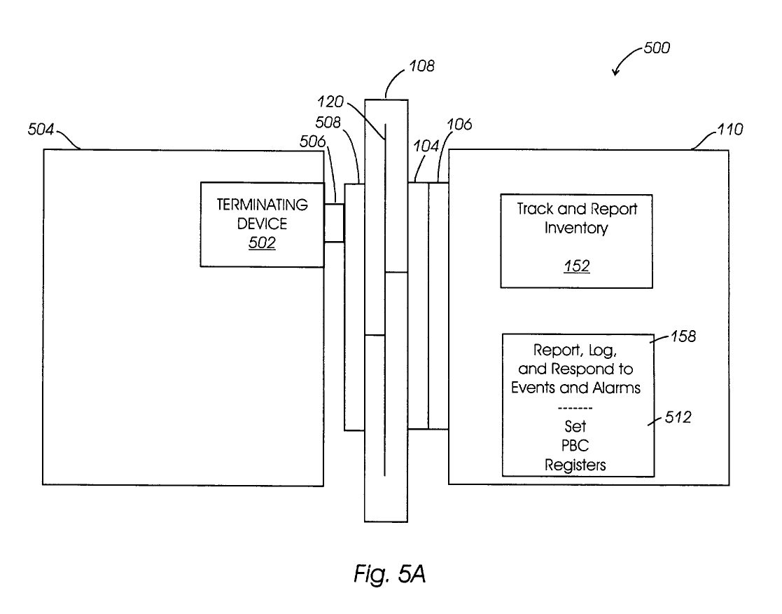

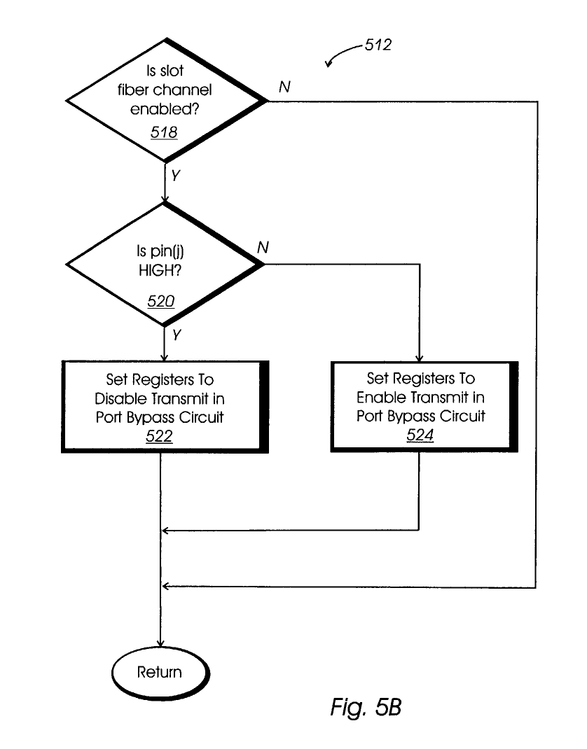

Referring now to FIG. 5A, a diagram of an example of terminating device 502 coupled to communicate with system management blade 110 in accordance with an embodiment of the present invention is shown. Terminating device 502 can be an electronic logic circuit mounted on support structure 504, such as a null device. In other embodiments, terminating device 502 can be implemented in an active device such as a printed circuit board using hardware, software, or a combination of hardware and software components. Connector portion 506 on support structure 504 interfaces with at least a portion of connector portion 508, which is coupled to mid-plane 108 and communicates with system management blade 110 via bus 120.

To determine when to open transmit switch 260, terminating device 502 includes a circuit component, such as a pull-up transistor (not shown), to pull a designated, unused pin in connector portion 508 HIGH. When system management blade 110 detects the designated pin being pulled HIGH, a function such as Track and Report Inventory function 152 detects the slot as being occupied by terminating device 502, and reports the event to Report, Log, and Respond to Events and Alarms function 158.

When the slot is fiber channel enabled, Set PBC Registers function 512 can be invoked to open or close transmit switch 260 (FIG. 2B).

Referring to FIGS. 2B, 5A, and 5B, FIG. 5B is a flow diagram of an embodiment of Set PBC Registers function 512 in accordance with an embodiment of the present invention for fiber channel enabled slots. Function 518 determines whether the slot being occupied is fiber channel enabled based on information from Track and Report Inventory function 152.

Function 520 determines whether the slot is occupied by terminating device 502 by detecting the state of the designated pin. If the slot is fiber channel enabled and the state of the designated pin is HIGH, function 522 sets one or more registers to disable transmissions to the slot, such as, for example, by opening transmit switch 260. If the slot is fiber channel enabled and the state of the designated pin is not HIGH, function 524 sets one or more registers to enable transmissions to the slot, such as, for example, by closing transmit switch 260 in PBC 240.

Note that terminating device 502 can be configured with one or more various types of components to affect the state of the designated pins. Further, the state of the pins can be set to HIGH or LOW by terminating device 502 to indicate when transmit switch 260 should be opened.

Note also that in some embodiments, a device similar to terminating device 502 and a function similar to function 512 (FIG. 5C) can be implemented in systems that do not support fiber channel capability, but in which it is still desired to prevent transmissions to lines that are not terminated. In such embodiments, function 520 can check the status of the designated pin set by terminating device 502 to determine whether to enable or disable transmissions.

The ability to prevent signals from being transmitted by one or more lines coupled to a connector portion by opening transmit switch 260 in port bypass circuit 240 (FIG. 2B) provides a very effective solution to the problem of EMI propagated by open connector portions. A function for detecting whether a slot is open, and to set transmit switch 260 accordingly, can be implemented as a standalone function or included with other functions performed by system management blade 110 (FIG. 1A). Various embodiments of the present invention can be utilized in systems that do not include FC-AL hub blades 114 or utilize arbitrated loops. Further, various embodiments of the present invention can be implemented in systems that utilize an arbitrated loop, but do not transmit or receive signals via fiber channels.

It is also important to note that a female connector portion can be coupled to conductive lines may also propagate EMI. In situations where transmissions to the female connector portion can be controlled by port bypass circuit 240, a function to set transmit switch 260 accordingly can be implemented as described for preventing transmissions on lines coupled to the female connector portion. Such would be the case, for example, where connector portions 302 is a female connector portion coupled to mid-plane 302.

Further, a function in accordance with the present invention, such as Set PBC Registers functions 512, can also include instructions to disable or enable switches on other lines, such as receive switch 262. In this manner, EMI can be reduced in a system by disabling transmissions along lines that are coupled to unterminated connectors. Additionally, in some embodiments, functions similar to Track and Report Inventory 152; Report, Log, and Respond to Events and Alarms 158; and Set PBC Registers function 512, can include instructions to detect whether a device is installed in a slot and control switches on transmission lines which are coupled to unterminated connectors whether or not the lines are coupled to PBC 240.

While the invention has been described with reference to various embodiments, it will be understood that these embodiments are illustrative and that the scope of the invention is not limited to them. Many variations, modifications, additions and improvements of the embodiments described are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the invention. Variations and modifications of the embodiments disclosed herein may be made based on the description set forth herein, without departing from the scope and spirit of the invention as set forth in the following claims.

In the claims, unless otherwise indicated the article “a” is to refer to “one or more than one”.

What is claimed is:

1. An apparatus for controlling transmissions to reduce electromagnetic interference in an electronic system, comprising:
a switch coupled to a conductive line; and
a system management device couplable to the electronic system, wherein the system management device is operable to:
detect whether a device is connected in a particular location in the system; and
open the switch to disable data transmission along the conductive line to the particular location when the device is not connected.

2. The apparatus according to claim 1 wherein:
the system management device is further operable to track inventory of a plurality of devices connected to a corresponding plurality of locations in the system.

3. The apparatus according to claim 2 wherein:
the system management device is further operable to detect when one of the plurality of devices is disconnected from the corresponding location in the system.

4. The apparatus according to claim 3 wherein:
the system management device and the plurality of devices are couplable to a communication bus.

5. The apparatus according to claim 4 wherein:
one of the plurality of devices is a hub comprising a second plurality of switches; and
the system management device is operable to communicate signals to the hub to open and close each of the second plurality of switches.

6. The apparatus according to claim 5 wherein:
the hub utilizes an arbitrated loop protocol.

7. The apparatus according to claim 5 wherein:
the hub utilizes a fiber channel arbitrated loop protocol.

8. The apparatus according to claim 1 wherein:
an identifier module on the device is operable to indicate to the system management device whether the device is connected to the particular location.

9. The apparatus according to claim 1 further comprising:
a terminating device operable to indicate to the system management device whether the device is connected to the particular location.

10. The apparatus according to claim 9 wherein:
the terminating device is operable to pull a designated pin on a connector portion to a designated state to indicate to the system management device whether the device is connected to the particular location.

11. A computer system comprising:
a connection plane comprising:
a plurality of connector portions;
a communication bus;
a system management device coupled to one of the plurality of connector portions;
a logic module in communication with the system management device, wherein the logic module is operable to:
detect when other devices are connected and disconnected to the plurality of connector portions via the communication bus;
detect whether the other devices are part of an arbitrated loop network; and
transmit a signal to disable transmission to at least one of the connector portions when the device in the arbitrated loop network corresponding to the at least one connector portion is disconnected.

12. The computer system according to claim 11 further comprising:
a hub, wherein the hub comprises a port bypass circuit.

13. The computer system according to claim 12 wherein the hub is operable to: receive data via optical fiber; and
transmit data via electrically conductive wire.

14. The computer system according to claim 11 wherein:
the hub comprises a plurality of port bypass circuits, and each port bypass circuit comprises a switch; and
the system management device is operable to communicate signals via the communication bus to the hub to open and close each of the switches.

15. The computer system according to claim 14 wherein:
the hub utilizes an arbitrated loop protocol.

16. The computer system according to claim 15 wherein:
the hub utilizes a fiber channel arbitrated loop protocol.

17. The computer system according to claim 11 wherein:
an identifier module connected to one of the connector portions is operable to indicate to the system management device whether one of the other devices is connected.

18. The computer system according to claim 11 further comprising:
a terminating device operable to indicate to the system management device whether one of the other devices is connected by setting the state of a designated pin in the connector portion to which the terminating device is connected to a designated value.

19. An apparatus for controlling transmissions to reduce electromagnetic interference in an electronic system comprising:
a port bypass circuit (PBC) comprising a switch coupled to one end of a transmission line, wherein the PBC is operable to receive a signal to open the switch to prevent data from being transmitted to the transmission line when a device is not connected to another end of the transmission line.

20. The apparatus according to claim 19 further comprising:
a hub, wherein the hub comprises the port bypass circuit.

21. The apparatus according to claim 20 wherein the hub is operable to:
receive data via optical fiber; and
transmit data via electrically conductive wire.

22. The apparatus according to claim 20 wherein:
the hub is coupled to receive signals via a communication bus to open and close the switch.

23. The apparatus according to claim 22 wherein:
the hub utilizes an arbitrated loop protocol.

24. The apparatus according to claim 22 wherein:
the hub utilizes a fiber channel arbitrated loop protocol.

25. The apparatus according to claim 23 wherein:
the hub is coupled to receive signals via a communication bus from a system management device, and the system management device transmits the signals to open the switch when the device is not connected.

26. The apparatus according to claim 25 wherein:
an identifier module indicates to the system management device whether the device is connected.

27. The apparatus according to claim 1 wherein:
a terminating device indicates to the system management device whether the device is connected.

28. The apparatus according to claim 27 wherein:
the terminating device is operable to pull a designated pin on a connector portion to a designated state to indicate to the system management device whether the device is connected.

29. A method for controlling electromagnetic interference in an electronic system, the method comprising:
detecting whether a connector portion is open; and
disconnecting a conductive line coupled to the connector portion when the connector portion is open, thereby disabling signal transmissions to the connector portion.

30. The method according to claim 29 further comprising:
reconnecting the conductive line when a device is connected to the connector portion.

31. The method according to claim 30 further comprising:
determining whether the device connected to the connector portion is fiber channel enabled.

32. The method according to claim 29 wherein:
disconnecting the conductive line includes opening a switch coupled to the conductive line.

33. The method according to claim 32 wherein:
reconnecting the conductive line includes closing a switch coupled to the conductive line.

34. The method according to claim 31 further comprising:
including the device in a fiber channel arbitrated loop when the device is fiber channel enabled.

35. The method according to claim 30 wherein:
disconnecting the conductive line includes opening a switch coupled to the conductive line; and
reconnecting the conductive line includes closing a switch coupled to the conductive line.

36. The method according to claim 35 wherein:
the switch is included in a port bypass circuit and the switch is controlled via a programming interface.

37. The method according to claim 36 wherein:
the port bypass circuit is included in a fiber channel arbitrated loop hub.

38. The method according to claim 29 wherein detecting whether the connector portion is open comprises:
coupling a terminating device to the connector portion;
setting the state of a designated pin on the connector portion to a designated state using the terminating device; and
detecting the state of the designated pin.

39. The method according to claim 29 wherein detecting whether the connector portion is open comprises:
coupling a identifier device to the connector portion;
transmitting an identifier to the system; and
detecting the identifier to determine the type of device that is connected to the connector portion.

40. The method according to claim 39 further comprising:
reconnecting the transmission line when a predesignated type of device is connected to the connector portion.
